(19) United States
(12) Patent Application Publication
(10) Pub. No.: US 2025/0170586 A1
(43) Pub. Date: May 29, 2025

(54) DEVICES FOR VORTEX FLOTATION MINERALIZATION BASED ON CONFINED SPACE AND METHODS FOR MINERALIZATION

(71) Applicants: CHINA UNIVERSITY OF MINING AND TECHNOLOGY, Xuzhou (CN); SHANXI ZHONGBODA CONSTRUCTION CO., LTD., Jincheng (CN)

(72) Inventors: Haijun ZHANG, Xuzhou (CN); Hainan WANG, Xuzhou (CN); Yubing HUO, Jincheng (CN); Xiaokang YAN, Xuzhou (CN); Quanzhi TIAN, Xuzhou (CN); Lijun WANG, Xuzhou (CN); Yanlin QIU, Jincheng (CN); Xiaoheng LI, Xuzhou (CN)

(73) Assignees: CHINA UNIVERSITY OF MINING AND TECHNOLOGY, Xuzhou (CN); SHANXI ZHONGBODA CONSTRUCTION CO., LTD., Jincheng (CN)

(21) Appl. No.: 19/031,295

(22) Filed: Jan. 17, 2025

Related U.S. Application Data
(63) Continuation-in-part of application No. PCT/CN2024/114810, filed on Aug. 27, 2024.

(30) Foreign Application Priority Data
Oct. 26, 2023 (CN) 202311405716.5

(51) Int. Cl. B03D 1/14; B03D 1/22

(52) U.S. Cl. CPC B03D 1/1418; B03D 1/22

(57) ABSTRACT

Provided are a device for vortex flotation mineralization based on confined space and a method for mineralization. The device includes a mineralizer body. An interior of the mineralizer body includes a mineralization cylinder for mineralizing minerals. A mineral inlet is provided on a sidewall at a bottom of the mineralization cylinder and a mineral outlet is provided on the sidewall at a top of the mineralization cylinder. The mineral inlet includes at least two inlet pipes arranged opposite to each other such that a mineral slurry enters the mineralization cylinder in a form of a collision flow. The device includes an air pipeline and a stirring device. The air pipeline is connected to the mineral inlet and configured to inject air into the mineral slurry. The stirring device is arranged inside the mineralization cylinder and provided with a mineralization impeller for stirring.

### CROSS-REFERENCE TO RELATED APPLICATIONS

This application is a Continuation-in-part of International Application No. PCT/CN2024/114810 filed on Aug. 27, 2024, which claims priority to Chinese Application No. 202311405716.5, filed on Oct. 26, 2023, the entire contents of each of which are incorporated herein by reference.

### TECHNICAL FIELD

The present disclosure relates to the technical field of mineral flotation, and in particular relates to a device for vortex flotation mineralization based on confined space and a method for mineralization.

### BACKGROUND

Flotation is an effective way of sorting fine-grained minerals, which has been widely used in energy, resource, chemical, and other industries. Using air bubbles as carriers, the separation of useful minerals and gangue minerals is realized in a complex gas-liquid-solid three-phase system based on a difference in hydrophobicity of particle surfaces. A mineralization process of particles and bubbles is a core link of the flotation process, which directly determines the efficiency and capacity of the flotation process, including three sub-processes of collision, adhesion, and detachment. In recent years, with the sustained high demand for mineral resources and large-scale development, high-grade ores are increasingly depleted, and low-grade complex ores become the focus of the future development and utilization of mineral resources. Complex composition and fine disseminated granularity are common physical properties of the low-grade complex ores. These ores require intensive crushing and dissociation before separation to liberate different component minerals, which further reduces the particle size of the mineral material processed by flotation. Hence, ultrafine grain minerals will become the primary particle size class in the flotation process.

During the flotation process, ultrafine grain minerals, due to their small size and low mass, lack sufficient inertial forces and are easily influenced by fluid streamlines near the bubble surfaces. Their strong affinity for water makes it difficult for them to collide with and directly contact bubbles. Moreover, after collision, the ultrafine grain minerals lack sufficient kinetic energy to displace the liquid film between the particles and bubbles, resulting in low adhesion efficiency. Numerous theoretical studies have shown that there is a fluid scale effect in the mineral flotation mineralization process. Specifically, the stronger a turbulence, the greater the turbulent dissipation, and the smaller a turbulent eddy scale, which favors forced ultrafine particles overcoming a flow line constraint of the fluid and increases the probability of collision and mineralization between the ultrafine particles and bubbles.

However, a strong turbulent flow field may deteriorate the static floatation separation environment, which is unfavorable to the separation process. Therefore, there is an urgent need to design a new type of strong turbulent collision mineralization device to replace the mineralization collection zone in conventional flotation systems, thereby achieving a modular distinction and process collaboration between strong turbulent mineralization and static separation, and enhancing the efficiency and capacity of the flotation process for ultrafine grain minerals.

### SUMMARY

To solve the above technical problems, one object of the present disclosure is to provide a device for vortex flotation mineralization based on confined space.

The device for vortex flotation mineralization based on confined space includes a mineralizer body. An interior of the mineralizer body includes a mineralization cylinder for mineralizing minerals. A mineral inlet is provided on a sidewall of the mineralization cylinder at a bottom of the mineralization cylinder and a mineral outlet is provided on the sidewall of the mineralization cylinder at a top of the mineralization cylinder, forming a mineralization pipeline within the mineralization cylinder that extends from the bottom to the top. The mineral inlet includes at least two inlet pipes arranged opposite to each other such that a mineral slurry enters the mineralization cylinder in a form of a collision flow. The device for vortex flotation mineralization further includes an air pipeline and a stirring device. The air pipeline is connected to the mineral inlet and configured to inject air into the mineral slurry. The stirring device is provided with a mineralization impeller for stirring, the mineralization impeller being positioned above a collision flow path between the at least two inlet pipes.

Another objective of the present disclosure is to provide a method for mineralization using the device for vortex flotation mineralization device based on confined space. The method includes:
S1: at the beginning of work, closing a discharge pipe and feeding minerals, opening the air pipeline to introduce air into slurry distribution pipes; allowing the mineral slurry to mix with the air for mineralization within the slurry distribution pipes; feeding the mineralized mineral slurry, through the mineral inlet, into an interior of the mineralization cylinder via the inlet pipes in the form of the collision flow; after the mineral slurry inside the mineralization cylinder reaches a set liquid level, activating the stirring device to disperse the air in the mineral slurry into fine bubbles, thereby enhancing the mineralization between the air and mineral particles in the mineral slurry;
S2: allowing the mineral particles to collide with the bubbles for mineralization within the mineralization cylinder, discharging the mineral slurry through the mineral outlet, and collecting the discharged slurry for subsequent processing;
S3: after the mineralization is completed, sequentially closing the air pipeline and the stirring device, stopping the feeding of the minerals, opening the discharge pipe, and emptying a residual slurry from the mineralization cylinder.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram of an exemplary structure of a device for mineralization according to some embodiments of the present disclosure;

FIG. 2 is a schematic diagram of an exemplary structure of a mineralization impeller according to some embodiments of the present disclosure;

FIG. 3 is a schematic diagram of an exemplary structure of a dispersion circulation impeller according to some embodiments of the present disclosure;

FIG. 4 is a schematic diagram of an automatic valve according to some embodiments of the present disclosure;

FIG. 5 is a schematic diagram of a mixing and aeration unit according to some embodiments of the present disclosure;

FIG. 6 is a schematic diagram of a heating device according to some embodiments of the present disclosure;

FIG. 7 is a schematic diagram of an auxiliary stirring device according to some embodiments of the present disclosure;

FIG. 8 is a flowchart of an exemplary process for obtaining a second slurry according to some embodiments of the present disclosure; and

FIG. 9 is a flowchart of an exemplary process for determining whether mineralization is completed or whether a mineralization progress satisfies a preset requirement according to some embodiments of the present disclosure.

Numerals in the drawings: 10, mineralization cylinder, 11, mineral inlet, 111, lined jet pipe, 12, mineral outlet, 13, discharge pipe, 14, sealing cover plate, 20, air pipeline, 21, air distribution pipe, 30, stirring device, 31, mineralization impeller, 32, dispersion circulation impeller, 33, air inlet, 34, aeration pipe, 35, aeration outlet, 36, auxiliary stirring device, 37, auxiliary stirring drive motor, 40, slurry distribution trough, 41, slurry distribution pipe, 42, automatic valve, 50, annular plate, 51, central hole, 50a, first annular plate, 50b, second annular plate, 50c, central annular plate, 52, baffle plate, 53, liner, 60, drive motor, 70, heating device.

### DETAILED DESCRIPTION

The following technical solutions of the present disclosure are described more specifically in connection with the embodiments and the accompanying drawings.

In order to provide a clearer understanding of the technical solutions of the embodiments described in the present disclosure, a brief introduction to the drawings required in the description of the embodiments is given below. It is evident that the drawings described below are merely some examples or embodiments of the present disclosure, and for those skilled in the art, the present disclosure may be applied to other similar situations without exercising creative labor. Unless otherwise indicated or stated in the context, the same reference numerals in the drawings represent the same structures or operations.

It should be understood that the terms “system,” “device,” “unit,” and/or “module” used herein are ways for distinguishing different levels of components, elements, parts, or assemblies. However, if other terms can achieve the same purpose, they may be used as alternatives.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to the embodiments described herein. It should be understood that the operations may not necessarily be performed in the exact sequence depicted. Instead, the operations may be performed in reverse order or concurrently. Additionally, other operations may be added to these processes, or one or more operations may be removed.

### Embodiment 1

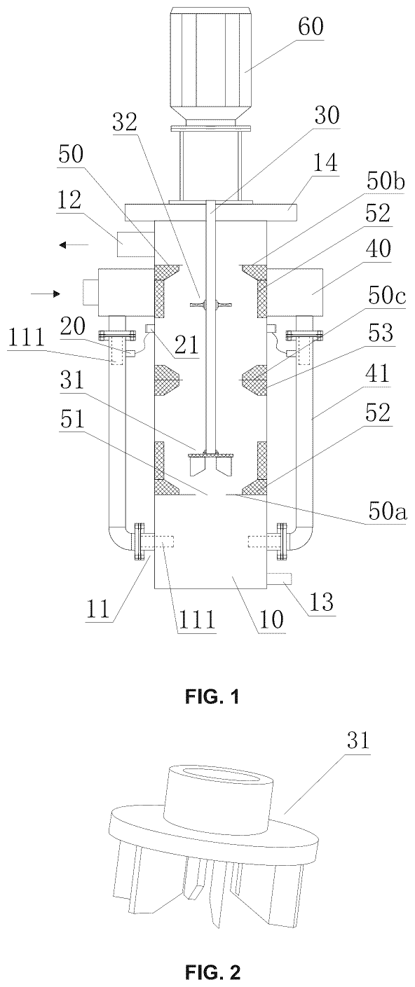

FIG. 1 shows a device for vortex flotation mineralization based on confined space comprising a mineralizer body. An interior of the mineralizer body includes a mineralization cylinder 10 for mineralizing minerals. In some embodiments, two ends of the mineralization cylinder 10 are sealed. A mineral inlet 11 is provided on a sidewall of the mineralization cylinder 10 at a bottom of the mineralization cylinder 10 and a mineral outlet 12 is provided on the sidewall of the mineralization cylinder 10 at a top of the mineralization cylinder 10, forming a mineralization pipeline within the mineralization cylinder 10 that extends from the bottom to the top. The mineral inlet 11 refers to a component for inputting a mineral slurry, the mineral outlet 12 refers to a component for outputting the mineral slurry, and the mineralization pipeline refers to a pipeline for the mineral slurry to flow therein. In some embodiments, the bottom of the mineralization cylinder 10 is also provided with a discharge pipe 13 for discharging a residual slurry within the mineralization cylinder 10 upon completion of mineralization.

In some embodiments, the mineral inlet 11 includes at least two inlet pipes arranged opposite to each other such that the mineral slurry enters the mineralization cylinder 10 in a form of a collision flow. The inlet pipes refer to lines for inputting the mineral slurry. The collision flow refers to a hydrodynamic phenomenon in the form of collision. For example, two or more streams of the mineral slurry enter the mineralization cylinder 10 in opposite directions and collide with each other in the mineralization cylinder to mix, forming the collision flow. On one hand, the collision flow enhances turbulent dissipation, induces small-scale vortices, and strengthens collision and adhesion between fine mineral particles and bubbles. On the other hand, the collision flow prevents the mineral slurry from piling up at the bottom of the mineralization cylinder, which may affect a working effect.

In some embodiments, a lined jet pipe 111, specifically a small-diameter inner lining jet pipe 111, is provided at a connection between each of the at least two inlet pipes and the mineralization cylinder 10 to enhance the collision flow. The small diameter refers to a diameter smaller than a diameter of the inlet pipe. The lined jet pipe 111 penetrates the sidewall of the mineralization cylinder 10 and extends a set distance into an interior of the mineralization cylinder 10. The diameter of the small-diameter lined jet pipe 111 is ¼ to ¾ of the diameter of the inlet pipe. The lined jet pipe 111 refers to an assembly for controlling an intensity of the collision flow. The set distance refers to a distance predetermined in advance.

In some embodiments of the present disclosure, the inlet pipe is connected to the lined jet pipe, which induces small-scale turbulent micro-vortices by extending into the mineralization cylinder and reducing in diameter to increase the intensity of the collision flow. By replacing lined jet pipes with different diameters and lengths, it is possible to regulate the intensity of the collision flow and induce different scales of turbulent micro-vortices to enhance the mineralization process of minerals with different physical properties.

The device for vortex flotation mineralization further includes an air pipeline 20 and a stirring device 30. The air pipeline 20 is connected to the mineral inlet 11 for feeding air to the mineral slurry. The stirring device 30 is provided inside the mineralization cylinder 10, and the stirring device 30 is provided with a mineralization impeller 31 for stirring. The mineralization impeller 31 is a semi-open impeller positioned above a collision flow path between the at least two inlet pipes. In some embodiments, the mineralization impeller 31 further disperses the air entering the mineral slurry by stirring, causing the air to further disperse and form fine bubbles to enhance mineralization.

In some embodiments of the present disclosure, strong turbulence is formed inside the mineralizer body through the collision flow of the mineral slurry and an impeller-induced high-speed stirring flow, which induces the formation of small-scale turbulent micro-vortices, enhancing an ability of fine mineral particles to break through the constraints of fluid streamlines and enabling collisions and attachment with bubbles, thereby achieving efficient mineralization of the fine mineral particles with bubbles.

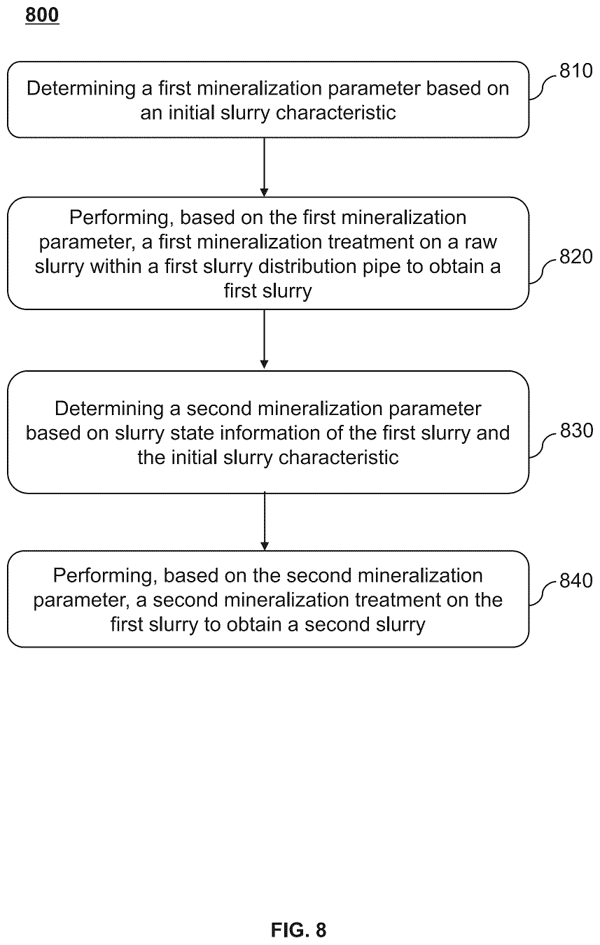

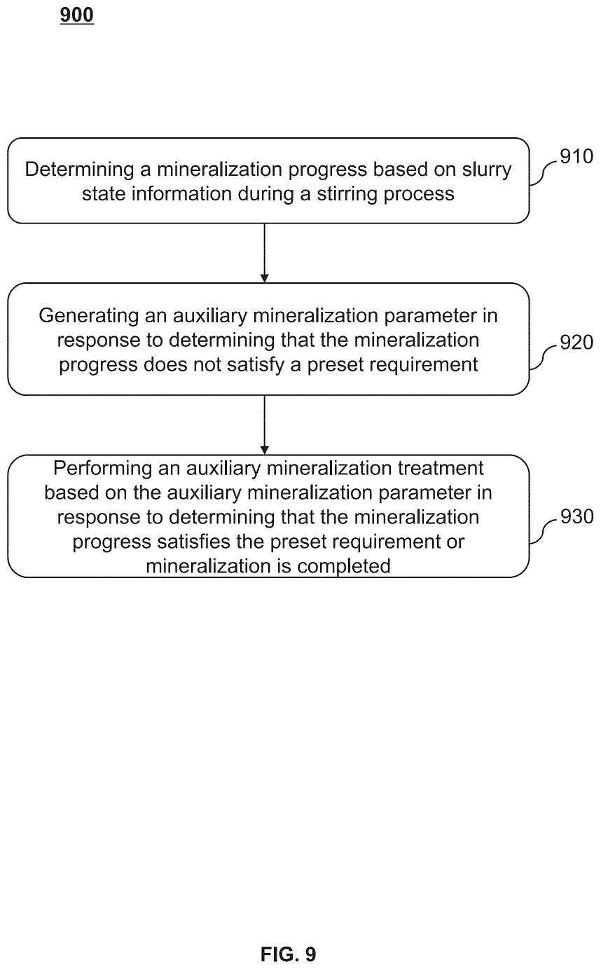

A top end of the mineralization cylinder 10 is sealed by a sealing cover plate 14, and the mineralizer body is further connected to a power device, which is electrically connected to the stirring device 30 in the mineralizer body. The power device includes a drive motor 60, and the drive motor 60 is provided on the sealing cover plate 14 on the top end of the mineralization cylinder 10. The mineralizer body may also be connected to a processor that is communicatively connected to the mineralizer body. The processor may be configured to obtain mineralization parameters of minerals to determine whether mineralization is completed. The mineralization parameters may include a first mineralization parameter, a second mineralization parameter, and an auxiliary mineralization parameter, and more relevant content may be found in the corresponding descriptions of FIG. 8 and FIG. 9.

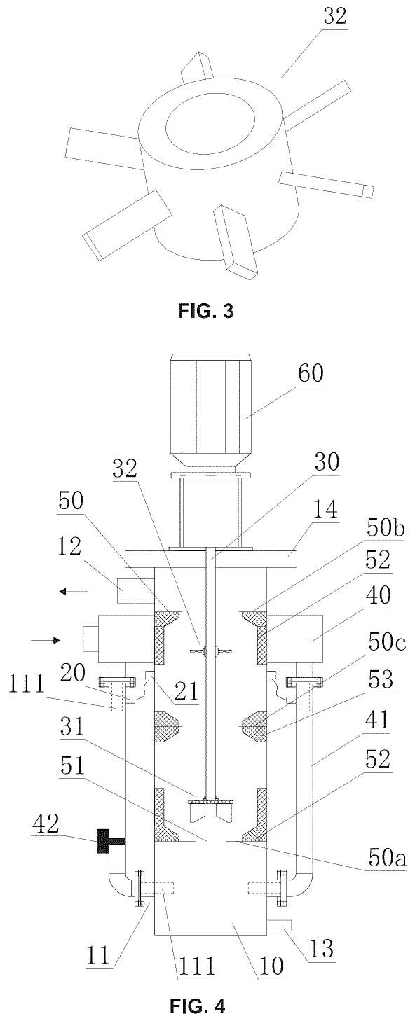

In some embodiments of the present disclosure, the stirring device 30 includes a rod having a stirring shaft. The stirring shaft is arranged along an axis of the mineralization cylinder 10. The mineralization impeller 31 is set at one end of the stirring shaft, and the other end of the stirring shaft is connected to the drive motor 60. Rotation of the stirring shaft drives the mineralization impeller 31 to work. At a position below the mineral outlet 12, the stirring shaft of the stirring device 30 is also provided with a dispersion circulation impeller 32, as shown in FIG. 3. The dispersion circulation impeller 32 is an open axial down-pumping impeller, i.e., blades of the dispersion circulation impeller 32 are inclined. A stirring action of the dispersion circulation impeller 32 provides axial kinetic energy to a fluid.

In some embodiments of the present disclosure, strong turbulence is formed inside the mineralizer body through the collision flow of the mineral slurry and an impeller-induced high-speed stirring flow, which induces the formation of small-scale turbulent micro-vortices, enhancing an ability of fine mineral particles to break through the constraints of fluid streamlines and enabling collisions and attachment with bubbles, thereby achieving efficient mineralization of the fine mineral particles with bubbles.

### Embodiment 2

Based on Embodiment 1, the mineral inlet 11 of the device for vortex flotation mineralization is further provided with a pressurization assembly to increase the intensity of the collision flow.

As shown in FIG. 1, the device for vortex flotation mineralization is further provided with a slurry distribution trough 40, which is a sealed conduit surrounding an outer sidewall of the mineralization cylinder 10. A mineral entry end of the mineral inlet 11 is provided on the slurry distribution trough 40, and the slurry distribution trough 40 is provided at a height such that the slurry distribution trough 40 is close to the mineral outlet 12. The slurry distribution trough 40 is connected to vertically arranged slurry distribution pipes 41, and a count of the slurry distribution pipes 41 matches a count of the at least two inlet pipelines, i.e., the count of the slurry distribution pipes 41 is the same as the count of the at least two inlet pipelines. In some embodiments, the mineral slurry enters the slurry distribution trough 40 and flows through the slurry distribution pipes 41 into the inlet pipes, in conjunction with the configuration of the lined jet pipe 111 to intensify the collision.

The air pipeline 20 is provided on the slurry distribution pipe 41. A lined jet pipe 111 is provided at a connection end of each of the slurry distribution pipes 41 connected to the slurry distribution trough 40, and the air pipeline 20 is located on a side of each of the slurry distribution pipes 41 near the corresponding lined jet pipe 111. The air pipeline 20 is configured to inject air into the mineral slurry in the slurry distribution pipes 41. The slurry distribution trough 40 feeds the mineral slurry into the slurry distribution pipes 41 through the lined jet pipe 111, and a jet from the lined jet pipe 111 may shear and disperse the air to form small bubbles, so as to make the bubbles and minerals mineralize in the slurry distribution pipes 41. The jet refers to a flow ejected from the lined jet pipe 111.

In some embodiments of the present disclosure, the mineral entry end of the mineral inlet is provided on the slurry distribution trough, which is connected to the slurry distribution pipes. The lined jet pipe is provided at the connection between the slurry distribution pipe and the slurry distribution trough, forming a strong shear mineral slurry jet within the slurry distribution pipe. This configuration induces the air fed from the air pipeline provided on the outer sidewall of the mineralization cylinder 10 and above the slurry distribution pipe to be dispersed and ruptured into fine bubbles under an action of the strong shear, thereby enhancing air dispersion. The mineral entry end of the mineral inlet is set on the slurry distribution trough, which is a sealed conduit surrounding the outer sidewall at the top of the mineralization cylinder. The slurry distribution trough is connected to the vertically arranged slurry distribution pipes, and the count of the slurry distribution pipes matches the count of the inlet pipes. After entering the slurry distribution trough, the mineral slurry flows through the slurry distribution pipes to the inlet pipes to intensify collision.

The air pipeline 20 further includes an air distribution pipe 21, which is connected to an external air pump to obtain air, and distribute the air equally to each air pipeline 20 connected to the corresponding slurry distribution pipe 41. The external air pump refers to a component configured to obtain air.

Additionally, a one-way valve is installed on the air pipeline 20 in a direction of air movement to avoid the mineral slurry from entering the air pipeline 20 and the air distribution pipe 21.

### Embodiment 3

On the basis of Embodiment 1 or Embodiment 2, the interior of the mineralization cylinder 10 includes a plurality of horizontally arranged annular plates 50, edges of the plurality of annular plates are tightly connected to an inner wall of the mineralization cylinder 10, and each of the annular plates has a central hole 51 through which the mineral slurry flows. The plurality of annular plates 50 includes a first annular plate 50a, a second annular plate 50b, and a central annular plate 50c. The three annular plates 50 divide the mineralization cylinder 10 into connected chambers for adjusting the mineralization intensity of different mineral particles inside the mineralization cylinder 10.

In some embodiments, two adjacent annular plates 50 and the inner wall of the mineralization cylinder 10 may form a zone chamber. A mineral particle refers to a tiny particle of a mineral, and a same mineral slurry may include mineral particles of different minerals.

The first annular plate 50a is arranged between the mineral inlet 11 and the mineralization impeller 31, and the first annular plate 50a and the bottom of the mineralization cylinder 10 form a collision flow mineralization chamber. The second annular plate 50b is arranged below the mineral outlet 12 at a position close to the mineral outlet 12. The second annular plate 50b and the top of the mineralization cylinder 10 forms a slurry discharge chamber. The central annular plate 50c is arranged between the first annular plate 50a and the second annular plate 50b. A dispersion circulation mineralization chamber is formed between the central annular plate 50c and the second annular plate 50b, and a vortex-forced mineralization chamber is formed between the central annular plate 50c and the first annular plate 50a.

In some embodiments of the present disclosure, the mineralization cylinder is provided with three layers of annular plates dividing the mineralization cylinder into four chambers, which are, from bottom to top, the collision flow mineralization chamber, the vortex-forced mineralization chamber, the dispersion circulation mineralization chamber, and the slurry discharge chamber. The vortex-forced mineralization chamber generates strong turbulence and induces small-scale turbulent micro-vortices through the high-speed rotary stirring of the mineralization impeller. On one hand, this arrangement strengthens the dispersion of air bubbles and generates micro-bubbles; on the other hand, it is conducive to forcing the fine mineral particles to break through the constraints of fluid streamlines and strengthen their mineralization with the bubbles. The dispersion circulation mineralization chamber generates an axial downward flow through the stirring of the dispersion circulation impeller located in the chamber, which prompts the mineral slurry to have a tendency to circulate downwardly, increases a retention time of the mineral particles in the mineralization cylinder, and improves a collision frequency of the mineral particles with the bubbles.

As the mineralization cylinder is divided into chambers by the annular plates 50, collision flow mineralization and the vortex mineralization occur sequentially in a direction of the mineralization pipeline in the device for vortex flotation mineralization.

Correspondingly, a turbulent dissipation gradient increases, and a turbulence vortex scale decreases, so as to adapt to different stages of a flotation mineralization process, and efficient flotation recovery of mineral particles is achieved through the gradient adaptation of turbulent energy. The collision flow mineralization refers to mineralization of the mineral slurry in the form of the collision flow, and vortex mineralization refers to mineralization of the mineral slurry in the form of a rotating vortex flow between the chambers. The turbulent dissipation refers to a process of turbulent energy consumption, the turbulent energy refers to a total amount of kinetic energy of the mineral slurry in the form of the vortex flow, and the turbulent vortex scale of a vortex refers to a size of the vortex that is formed by the mineral slurry rotating between the chambers.

In the collision flow mineralization chamber, the mineral inlet 11 is provided with the at least two inlet pipes so that the mineral slurry enters the mineralization cylinder 10 in the form of the collision flow. On one hand, this arrangement enhances turbulence dissipation, induces small-scale vortices, and strengthens collision and adhesion between fine mineral particles and bubbles. On the other hand, this arrangement prevents the mineral slurry from piling up at the bottom of the mineralization cylinder, which may affect the working effect.

In some embodiments of the present disclosure, since the top of the mineralization cylinder 10 is a confined space, a high-pressure solution environment is likely to form inside the mineralizer body during a working process, which strengthens the concentration of energy and enhances turbulent movement. Meanwhile, in the high-pressure solution environment, a solubility of air is enhanced, which is conducive to the generation of micro-nano bubbles, strengthening air dispersion and interfacial nano bubble bridging, thereby providing suitable bubble carriers and an interfacial mineralization condition for the floatation mineralization of fine minerals particles.

The mineralization impeller 31 is provided in the vortex-forced mineralization chamber. As shown in FIG. 2, the mineralization impeller 31 is a semi-open radial impeller, with blades arranged vertically, making a fluid to move in a horizontal plane after being stirred. High-speed rotation of the mineralization impeller 31 generates strong turbulence and induces small-scale turbulent micro-vortices, which enhance bubble dispersion and generate microbubbles, which is conducive to further forcing the fine mineral particles to break through the fluid streamline constraints, strengthening their mineralization with bubbles. The dispersion circulation impeller 32 is arranged in the dispersion circulation mineralization chamber. The dispersion circulation impeller 32 is an open axial down-pumping impeller that generates axial down-pumping flow with its high-speed rotation, which promotes a downward circulation movement of the slurry, thereby enhancing the retention time of mineral particles within the cylinder, and increasing their collision frequency with bubbles.

In some embodiments, a diameter of the central hole 51 of the first annular plate 50a is less than or equal to a diameter of an inlet of the mineralization impeller 31, and a diameter of the central hole 51 of the central annular plate 50c and a diameter of the central hole 51 of the second annular plate 50b are both greater than the diameter of the inlet of the mineralization impeller 31 and a diameter of the blades of the dispersion circulation impeller 32.

Each of an upper surface of the first annular plate 50a and a lower surface of the second annular plate 50b is provided with a plurality of baffle plates 52 arranged radially around a periphery of the central hole 51 of the annular plate 50, a long side of each of the baffle plates 52 fits against the inner wall of the mineralization cylinder 10, and a width of each of the baffle plates 52 is shorter than an annular width of the annular plate 50. Each of an upper surface and a lower surface of the central annular plate is provided with liners 53 arranged radially around a periphery of the central hole 51 of the central annular plate 50c, a long side of each of the liners 53 fits against the inner wall of the mineralization cylinder 10, and a width of each of the liners 53 is shorter than an annular width of the central annular plate 50c.

The baffle plates 52 and the liners 53 may support the annular plates 50, and prevent the mineral slurry from forming an inertial swirling flow attached to the inner wall of the mineralization cylinder 10, so as to improve the effect of the mineralization. To further avoid the formation of the inertial swirling flow, the baffle plates 52 provided at the upper surface of the first annular plate 50a extend upwardly to a position exceeding a top surface of the mineralization impeller 31, and the liners 53 provided on the lower surface of the second annular plate 50b extend downwardly to a position exceeding a bottom surface of the dispersion circulation impeller 32.

In some embodiments of the present disclosure, the same count (e.g., 4-8) of baffle plates 52 and liners 53 are uniformly arranged around the central hole 51 of the annular plate 50. However, in practical applications, there are no specific requirements for the count, shape, etc., of the baffle plates 52 and the liners 53; adjustments may be made according to mineralization needs.

### Embodiment 4

The present disclosure provides a method for mineralization using the device for vortex flotation mineralization based on confined space described in the above embodiments. The method may include:
S1: when starting work, closing the discharge pipe 13 and feeding minerals, opening the air pipeline 20 to introduce air into slurry distribution pipes; allowing the mineral slurry to mix with the air for mineralization within the slurry distribution pipes; feeding the mineralized mineral slurry, through the mineral inlet 11, into an interior of the mineralization cylinder 10 via the inlet pipes in the form of the collision flow; after the mineral slurry inside the mineralization cylinder 10 reaches a set liquid level, activating the stirring device 30 to disperse the air in the mineral slurry into fine bubbles, thereby enhancing the mineralization between the air and mineral particles in the mineral slurry.
S2: allowing the mineral particles to collide with the bubbles for mineralization within the mineralization cylinder 10, discharging the mineral slurry through the mineral outlet 12, and collecting the discharged slurry for subsequent processing, wherein the mineral slurry discharged from the mineral outlet 12 is an air-containing mineral slurry after the mineral particles are mineralized by collision with the bubbles;
S3: after the mineralization is completed, sequentially closing the air pipeline 20 and the stirring device 30, stopping the feeding of the minerals, opening the discharge pipe 13, and emptying a residual slurry from the mineralization cylinder 10.

When the slurry distribution trough 40 is provided at an inlet of the mineralization pipeline, the above operations remain unchanged, with only an addition of a flow process of the mineral slurry in the slurry distribution trough 40 and the air pipeline 20, which injects air into the slurry distribution pipes 41 for mineralization, details of which will not be described herein.

In some embodiments of the present disclosure, in the vortex-forced mineralization chamber, collision flows colliding with each other are generated at the bottom of the mineralization cylinder through the inlet pipes. On one hand, this enhances turbulent dissipation, induces small-scale vortices, and strengthens the collision and adhesion of fine mineral particles with bubbles. On the other hand, it prevents the slurry from accumulating at the bottom of the mineralization cylinder, which may affect operational efficiency. The device for vortex flotation mineralization has a closed restricted space at the top, and during operation, a high-pressure solution environment forms inside the mineralization cylinder, further concentrating energy and enhancing turbulent motion. Additionally, in a high-pressure solution environment, the solubility of air increases, facilitating the generation of micro-nano bubbles, enhancing air dispersion, and enabling interface bridging by nano bubbles. This provides suitable bubble carriers and an interfacial mineralization condition for the flotation mineralization of fine mineral particles.

FIG. 4 is a schematic diagram of an automatic valve according to some embodiments of the present disclosure.

In some embodiments, as shown in FIG. 4, an automatic valve is provided inside the lined jet pipe 111. The automatic valve may be configured to regulate an impact force of a mineral slurry entering a mineralization cylinder to adjust an intensity of a collision flow.

The automatic valve 42 refers to a one-way valve that is capable of automatic adjustment. As shown in FIG. 4, the automatic valve 42 is provided inside the lined jet pipe. In some embodiments, the automatic valve regulates a flow volume and a flow velocity of the mineral slurry passing through the automatic valve.

The impact force refers to a force generated when two or more streams of mineral slurry collide within the mineralization cylinder. In some embodiments, the automatic valve may regulate the impact force by adjusting the flow velocity and the flow volume of the mineral slurry passing through the automatic valve.

The intensity of the collision flow refers to a severity level of collision when a plurality of steams of mineral slurry strike each other in opposite directions. In some embodiments, the intensity of the collision flow may be expressed by a numerical value, with a larger value indicating a greater intensity of the collision flow.

In some embodiments of the present disclosure, adjusting the impact force of the mineral slurry and the velocity of the collision flow in the lined jet pipe based on the automatic valve is conducive to improving a fusion effect of the air and the mineral slurry, which in turn improves a mineralization effect.

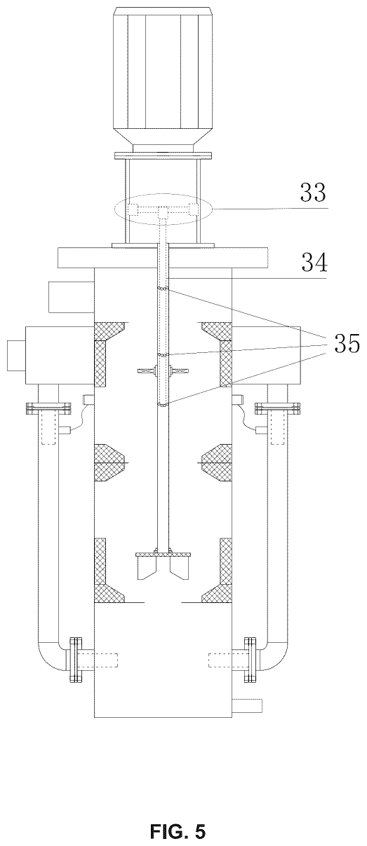

FIG. 5 is a schematic diagram of a mixing and aeration unit according to some embodiments of the present disclosure.

In some embodiments, a mixing and aeration unit is provided in the stirring device as shown in FIG. 5. The mixing and aeration unit includes an air inlet 33, an aeration pipe 34, and an aeration outlet 35.

The mixing and aeration unit refers to a module for stirring and aeration. In some embodiments, the mixing and aeration unit may be configured to introduce air to a stirring center of the stirring device during stirring.

The air inlet refers to a component for obtaining air from outside the mineralization cylinder, the aeration pipe refers to a component for transporting air from the air inlet to the stirring center, and the aeration outlet refers to a component for feeding air to the stirring center. In some embodiments, as shown in FIG. 5, the air inlet 33 is connected to the aeration pipe 34, and the aeration pipe 34 that is connected to the air inlet 33 extends into the stirring center through the aeration outlet 35.

In some embodiments of the present disclosure, feeding air to the stirring center based on the air inlet, the aeration pipe, and the aeration outlet is conducive to thorough mixing between the mineral slurry and the air during mineralization, which in turn improves the mineralization effect of the mineral slurry.

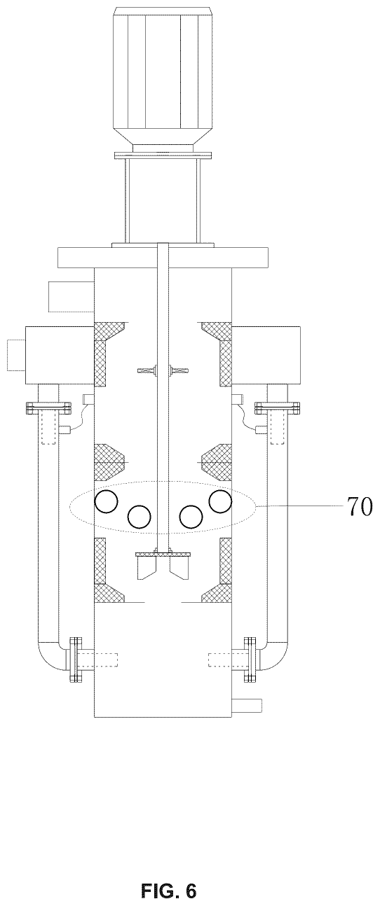

FIG. 6 is a schematic diagram of a heating device according to some embodiments of the present disclosure.

In some embodiments, a mineralization cylinder is provided with a heating device 70, as shown in FIG. 6.

The heating device refers to a device for heating the mineralization cylinder. In some embodiments, the heating device may be configured to heat a mineral slurry within the mineralization cylinder. The heating device may include, but is not limited to, one of an electric heater, a steam heater, a gas heater, etc. In some embodiments, the heating device may be uniformly disposed on an outer wall or an inner wall of the mineralization cylinder. In some embodiments, by adjusting a temperature of the mineralization cylinder based on the heating device, adhesion between mineral particles and bubbles as well as a flow velocity of the mineral slurry can be modified. For example, a higher temperature of the mineralization cylinder results in increased slurry fluidity, and when the temperature of the mineralization cylinder is within a preset temperature range, the adhesion between the mineral particles and the bubbles is relatively great. The preset temperature range may be determined by a technician based on prior experience.

In some embodiments of the present disclosure, heating the mineral slurry inside the mineralization cylinder based on the heating device is conducive to increasing a mineralization rate of the mineral slurry, thereby improving mineralization efficiency.

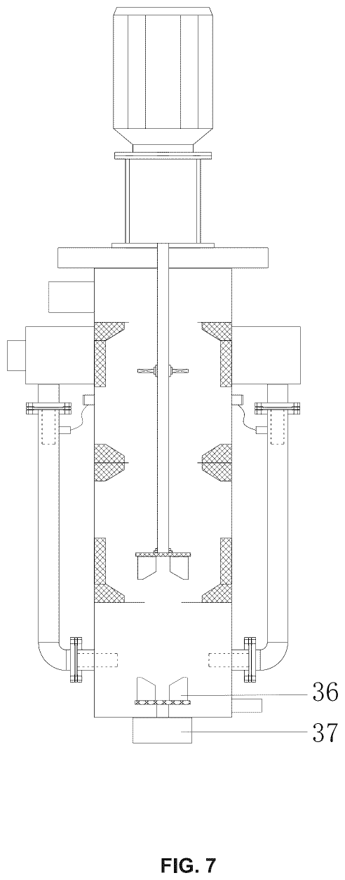

FIG. 7 is a schematic diagram of an auxiliary stirring device according to some embodiments of the present disclosure.

In some embodiments, an auxiliary stirring device 36 may be provided at a bottom of a mineralization cylinder as shown in FIG. 7.

The auxiliary stirring device 36 refers to a device that assists the stirring device 30 in the mineralization cylinder with stirring. In some embodiments, the auxiliary stirring device 36 may be configured to stir a mineral slurry at the bottom of the mineralization cylinder. In some embodiments, the auxiliary stirring device 36 may be provided on an inner wall of the mineralization cylinder at the bottom of the mineralization cylinder. In some embodiments, the auxiliary stirring device 36 may be connected to an auxiliary stirring drive motor 37, and the auxiliary stirring drive motor 37 may be provided on an outer wall of the mineralization cylinder at the bottom of the mineralization cylinder. In some embodiments, the auxiliary stirring drive motor 37 may be configured to power the auxiliary stirring device 36.

In some embodiments of the present disclosure, assisting the stirring process in the mineralization cylinder based on the auxiliary stirring device is conducive to increasing a stirring speed of the mineral slurry at the bottom of the mineralization cylinder, which in turn enables the mineral slurry at the bottom to be sufficiently stirred, thereby improving mineralization effect of the mineral slurry at the bottom of the mineralization cylinder.

In embodiments of the present disclosure, the following method for mineralization (e.g., process 800 and process 900) using the device for vortex flotation mineralization based on constrained space may be executed by a processor in an externally connected computer. The processor may be communicatively connected to a stirring device, an automatic valve, an auxiliary stirring device, a heating device, or the like, in the device for vortex flotation mineralization, and control an operating parameter of a mineralizer body of the device for vortex flotation mineralization.

FIG. 8 is a flowchart of an exemplary process for obtaining a second slurry according to some embodiments of the present disclosure.

In some embodiments, the processor may be configured to determine a first mineralization parameter based on an initial slurry characteristic; perform, based on the first mineralization parameter, a first mineralization treatment on a raw slurry within a first slurry distribution pipe to obtain a first slurry; determine a second mineralization parameter based on slurry state information of the first slurry and the initial slurry characteristic; and perform, based on the second mineralization parameter, a second mineralization treatment on the first slurry to obtain a second slurry. Process 800 may include the following operations:

In 810, determining a first mineralization parameter based on an initial slurry characteristic.

The initial slurry characteristic refers to a characteristic associated with a raw slurry. The raw slurry refers to a mineral slurry that has not been mineralized. In some embodiments, the initial slurry characteristic may include parameters such as temperature, density, composition, or the like.

For example, the composition of the initial slurry characteristic may include one or more of a ratio of mineral to water in the mineral slurry, types of flotation reagents and concentrations thereof, or the like. The types of flotation reagents may include, but are not limited to, dispersants, activators, collectors, or the like. In some embodiments, the composition of the initial slurry characteristic may be directly input by a user.

In some embodiments, the initial slurry characteristic may be obtained by a status detection instrument.

The status detection instrument refers to an instrument for obtaining characteristics of the mineral slurry. For example, the status detection instrument may include a thermometer, a densitometer, or the like. In some embodiments, the status detection instrument is not part of the device for vortex flotation mineralization of the present disclosure, and the user may obtain the initial slurry characteristic through a status detection equipment instrument independent of the device for vortex flotation mineralization.

The first mineralization parameter refers to a parameter for mineralization of the raw slurry mixed with air. In some embodiments, the first mineralization parameter may include an injection rate of the mineral slurry, a flow velocity of air within the air pipeline, or the like.

In some embodiments, the processor may determine the first mineralization parameter by querying a first parameter table based on the initial slurry characteristic. The first parameter table may be constructed by a technician based on historical mineralization data in a historical mineralization record where a mineralization effect is qualified, and the mineralization effect is manually marked by the technician. The technician may refer to slurry state information obtained by a detection instrument when marking the mineralization effect.

In some embodiments, the processor may also determine the first mineralization parameter through vector query based on the initial slurry characteristic. Merely by way of example, the processor may construct a first vector database including a plurality of first reference vectors and a plurality of first reference labels corresponding the plurality of first reference vectors. The first vector database may be constructed based on the historical mineralization record. The first reference vector may consist of a historical initial slurry temperature, a historical initial slurry density, and a historical initial slurry composition. The first reference label is a historical first mineralization parameter corresponding to the first reference vector where mixing between the raw slurry and air in historical data resulted in a relatively effective mineralization. The relatively effective mineralization of the raw slurry and air mineralization refers to a degree of mineralization of the mixing between the raw slurry and air meets a production requirement, with the degree of mineralization of the first slurry after mineralization meeting standards without over-mineralization.

In some embodiments, the processor may construct a first to-be-matched vector based on an initial slurry temperature, an initial slurry density, and an initial slurry composition, search the first vector database, and determine a plurality of first similarities between the first to-be-matched vector and a plurality of first reference vectors. The processor may determine a first reference vector with a highest first similarity, and designate a first reference label corresponding to the first reference vector as the first mineralization parameter. The first similarity may be expressed by a cosine similarity, a Euclidean distance, or the like.

In some embodiments, the processor may also determine the first mineralization parameter based on the initial slurry characteristic via a first mineralization model.

The first mineralization model refers to a model for determining the first mineralization parameter. In some embodiments, the first mineralization model may be a machine learning model, for example, a Convolutional Neural Network (CNN) model, a Recurrent Neural Network (RNN) model, or the like.

In some embodiments, an input of the first mineralization model may include the initial slurry characteristic, and an output of the first mineralization model may include the first mineralization parameter.

In some embodiments, the processor may train the first mineralization model based on a plurality of first training samples with first training labels.

In some embodiments, a set of first training samples may include sample initial slurry characteristics. The first training samples may be obtained based on historical data. For example, the sample initial slurry characteristics may be historical initial slurry characteristics of a historical mineralization process.

In some embodiments, the first training label may be a historical first mineralization parameter corresponding to the first training sample where mixing between the raw slurry and air in historical data resulted in a relatively effective mineralization. The relatively effective mineralization of the raw slurry and air mineralization refers to a degree of mineralization of the mixing between the raw slurry and air meeting a production requirement, with the degree of mineralization of the first slurry after mineralization meeting standards without over-mineralization. The first training label may be labeled by the processor and/or manually based on the historical data. For example, the processor and/or a technician may statistically obtain actual first mineralization parameters from a large amount of historical data and annotate them as the first training labels.

In some embodiments, the processor may input the first training samples into an initial first mineralization model, construct a first loss function based on the first training labels and a first mineralization parameter output from the initial first mineralization model, and update the initial first mineralization model based on the first loss function. When a first predetermined condition is satisfied, the training of the initial first mineralization model training is completed to obtain the trained initial first mineralization model. The first predetermined condition may include the first loss function converging, a count of iterations reaching a threshold, or the like.

In some embodiments of the present disclosure, determining the first mineralization parameter based on the initial slurry characteristic through the first mineralization model can determine the first mineralization parameter more accurately, reduce errors, and thereby improving the mineralization effect of the mineral slurry.

In 820, performing, based on the first mineralization parameter, a first mineralization treatment on a raw slurry within a first slurry distribution pipe to obtain a first slurry.

The first slurry distribution pipe refers to a component for mineralization of the raw slurry. In some embodiments, the first slurry distribution pipe is similar to the slurry distribution pipe 41, and more on the slurry distribution pipe 41 may be found in the relevant descriptions of Embodiment 2 and Embodiment 4.

The first mineralization treatment refers to an operation of mineralizing the raw slurry into the first slurry. In some embodiments, the raw slurry may be mineralized by mixing with air within the first slurry distribution pipe.

The first slurry refers to the raw slurry after the first mineralization treatment.

In some embodiments, the processor may control a rate at which the raw slurry is injected into the first slurry distribution pipe and an air flow rate based on the first mineralization parameter.

In 830, determining a second mineralization parameter based on slurry state information of the first slurry and the initial slurry characteristic.

The slurry state information refers to status information of the mineralized mineral slurry. In some embodiments, the slurry state information may include the size of air bubbles in the mineral slurry, an adhesion condition of mineral particles, or the like.

The adhesion condition of mineral particles refers to a degree to which the mineral particles and the air bubbles are attached to each other. In some embodiments, the adhesion condition of mineral particles may be represented by a numerical value, where the higher the value is, the better the adhesion condition of mineral particles is.

The slurry state information is obtained after all of the mineral slurry has flowed into the mineralization cylinder. In some embodiments, the processor may obtain the slurry state information via a detection device. The detection device may include, but is not limited to, one or more of an ultrasonic detector, a sensor, a spectrometer, a strength analyzer, or the like.

The second mineralization parameter refers to a parameter for mineralization of the first slurry. In some embodiments, the second mineralization parameter may include a stirring parameter of the stirring device 30, etc.

The stirring parameter refers to a parameter of the stirring device. In some embodiments, the stirring parameter may include a rotation speed, a rotation period, a rotation duration, or the like, of the stirring device.

In some embodiments of the present disclosure, the processor may obtain the stirring parameter of the stirring device based on a status detection device. The status monitoring device may include, but is not limited to, one or more of a rotation sensor, a magnetic sensor, a frequency monitoring device, or the like.

In some embodiments, the second mineralization parameter may further include a valve level of the automatic valve 42.

The valve level refers to a parameter used to describe an opening size of the automatic valve. In some embodiments, the higher the valve level is, the larger a passageway opened is by the automatic valve, resulting in a greater flow volume of the outflowing mineral slurry, and a lower flow velocity of the mineral slurry. The lower the valve level is, the smaller the passageway is opened by the automatic valve, resulting in a smaller flow volume of the outflowing mineral slurry, and a greater flow velocity of the mineral slurry.

In some embodiments of the present disclosure, adjusting the flow volume and the flow velocity of the mineral slurry in the automatic valve based on the valve level is beneficial for improving the accuracy of control in the flow volume and the flow velocity of the mineral slurry and improving the efficiency of the second mineralization parameter.

In some embodiments, the processor may construct a second to-be-matched vector based on the slurry state information of the first slurry and the initial slurry characteristic, and determine the second mineralization parameter by querying a second vector database.

Merely by way of example, the processor may construct a second vector database which may include a plurality of second reference vectors and their corresponding second reference labels. The second vector database may be constructed based on a historical mineralization record. The second reference vectors may include historical slurry state information and historical initial slurry characteristics. The second reference labels correspond to the second reference vectors may include historical second mineralization parameters from historical data that resulted in a relatively good mineralization treatment effect on the first slurry. The relatively good mineralization treatment effect means that the mineralization process of the first slurry meets production requirements, achieving a desired level of mineralization in the second slurry without over-mineralization.

In some embodiments, the processor may construct the second to-be-matched vector based on the slurry state information, the initial slurry characteristic, perform retrieval in the second vector database, and determine a plurality of second similarities between the second to-be-matched vector and a plurality of second reference vectors. The processor may determine a second parameter vector with a highest second similarity, and designate a second reference label corresponding to the second parameter vector as the second mineralization parameter. The second similarity may be expressed by a cosine similarity, a Euclidean distance, or the like.

In some embodiments, the processor may evaluate a collision sufficiency to adjust the valve level based on slurry collision information, and determine the stirring parameter of the stirring device based on the slurry state information and the initial slurry characteristic.

The slurry collision information refers to information related to the collision of the mineral slurry flowing out of two lined jet pipes opposite to each other. In some embodiments, the slurry collision information may include a height of a collision point, the flow volume of the mineral slurry, or the like.

In some embodiments, the processor may obtain the slurry collision information based on a computer vision technology via a detection device. The computer vision technology may include a computer vision recognition model, an image recognition algorithm, a feature comparison algorithm, or the like. The computer vision recognition model may include a residual network model, a visual geometry group (VGG) network model, etc. The image recognition algorithm may include a Canny edge detection algorithm, etc. The feature comparison algorithm may include a support vector machine algorithm, a decision tree algorithm, etc.

The height of the collision point refers to a height of the collision point from a bottom of the mineralization cylinder. In some embodiments, the higher the collision point is, the larger a flow velocity of the outflowing mineral slurry, and the higher an intensity of collision. In some embodiments, the height of the collision point is positively correlated with the flow velocity of the mineral slurry.

In some embodiments, the processor may determine the collision point through computer vision techniques, thereby determining the height of the collision point.

The flow volume of the mineral slurry refers to an amount of the mineral slurry passing through the lined jet pipe per unit of time. In some embodiments, the processor may determine the flow volume of the mineral slurry based on the flow velocity of the mineral slurry and a cross-sectional area of the lined jet pipe. The cross-sectional area of the lined jet pipe is positively correlated with a thickness of a mineral slurry column. The mineral slurry column refers to a column of mineral slurry formed by the mineral slurry flowing out of the lined jet pipe.

In some embodiments of the present disclosure, the processor may obtain a relationship between the thickness of the mineral slurry column and the cross-sectional area of the lined jet pipe based on actual measurements and determine the flow volume of the mineral slurry based on the height of the collision point and the thickness of the mineral slurry column. For example, the processor determines a relationship between the height of the collision point and the flow velocity of the mineral slurry through knowledge of physical kinematics (e.g., knowledge related to parabolic motion) to determine the flow velocity of the mineral slurry. Then based on the relationship between the thickness of the mineral slurry column and the cross-sectional area of the lined jet pipe obtained from the actual measurements, the processor determines the cross-sectional area of the lined jet pipe based on the thickness of the mineral slurry column, and determines the flow volume based on the flow velocity and the cross-sectional area.

The collision sufficiency refers to a degree of thoroughness of collision of the mineral slurry. In some embodiments of the present disclosure, the collision sufficiency may be represented by a numerical value, where the larger the value is, the greater the collision sufficiency is. In some embodiments of the present disclosure, the collision sufficiency is positively correlated with the height of the collision point and the flow volume of the mineral slurry.

For example, the collision sufficiency may be expressed as a product of the height of the collision point and the flow volume of the mineral slurry.

In some embodiments of the present disclosure, the processor may adjust the valve level based on the collision sufficiency and a sufficiency threshold. The sufficiency threshold may be preset based on historical experience.

For example, if the collision sufficiency is below the sufficiency threshold, the processor controls fine-tuning of the valve level in any adjustment direction, such as increasing or decreasing by one level, and then re-determine the collision sufficiency. If the collision sufficiency improves after the fine-tuning in a direction, the processor continues fine-tuning in the direction until the sufficiency threshold is reached or the collision sufficiency no longer improves. If the collision sufficiency decreases after the fine-tuning, the processor adjusts the valve level in an opposite direction until the sufficiency threshold is reached or the collision sufficiency no longer improves.

In some embodiments of the present disclosure, obtaining collision information in real time to adjust the valve level during the process of feeding the mineral slurry into the mineralization cylinder can ensure sufficient collision of the mineral slurry inside the cylinder, thereby improving flotation efficiency.

In 840, performing, based on the second mineralization parameter, a second mineralization treatment on the first slurry to obtain a second slurry.

The second mineralization treatment refers to an operation of mineralizing the first slurry into the second slurry. In some embodiments of the present disclosure, the first slurry may be subjected to the second mineralization treatment in the mineralization cylinder.

The second slurry refers to a product of the mineralization of the first slurry in the mineralization cylinder.

In some embodiments of the present disclosure, the processor, based on the second mineralization parameter, adjusts the stirring parameter of the stirring device and/or the valve level of the automatic valve to perform the second mineralization treatment on the first slurry and air to obtain the second slurry.

In some embodiments of the present disclosure, performing the first mineralization treatment and the second mineralization treatment based on the initial slurry characteristic is beneficial to sufficiently mix the mineral slurry and the air, thereby increasing a collision probability of mineral particles with air bubbles, thus improving a flotation effect for the mineral particles.

FIG. 9 is a flowchart of an exemplary process for determining whether mineralization is completed or whether a mineralization progress satisfies a preset requirement according to some embodiments of the present disclosure.

In some embodiments of the present disclosure, the processor may determine a mineralization progress based on slurry state information during a stirring process; generate an auxiliary mineralization parameter in response to determining that the mineralization progress does not satisfy a preset requirement; and perform an auxiliary mineralization treatment based on the auxiliary mineralization parameter in response to determining that the mineralization progress satisfies the preset requirement or the mineralization is completed. Process 900 may include the following operations: In 910, determining a mineralization progress based on the slurry state information during a stirring process.

The stirring process refers to a process in which a mineral slurry is stirred in a mineralization cylinder. In some embodiments of the present disclosure, the second mineralization treatment includes the stirring process.

The mineralization progress refers to a progress of mineralization of the mineral slurry. In some embodiments of the present disclosure, the mineralization progress may include multiple stages. For example, the mineralization progress may include a contact stage, an adhesion stage, an upwelling stage, a formation stage of a stable foam layer, or the like. The foam layer consists of fine bubbles that are at a top of the mineral slurry and attached to mineral particles.

In some embodiments of the present disclosure, the processor may determine the mineralization progress by vector querying based on slurry state information during the stirring process.

The processor may construct a third vector database including a plurality of third reference vectors and their corresponding third reference labels. The third vector database may be constructed based on a historical mineralization record. The third reference vectors may be constructed based on historical slurry state information, and the third reference labels may be mineralization progresses corresponding to the third reference vectors.

In some embodiments of the present disclosure, the processor may construct a third to-be-matched vector based on the slurry state information, search the third vector database, and determine a plurality of third similarities between the third to-be-matched vector and the plurality of third reference vectors. The processor may determine a third reference vector with a highest similarity, and designate a third reference label corresponding to the third reference vector as the mineralization progress.

In some embodiments of the present disclosure, the processor may determine the mineralization progress through any other feasible manner. For example, the processor determines the mineralization progress based on the slurry state information during the stirring process by querying a status table. The status table may include historical slurry state information during historical stirring processes and mineralization progresses corresponding to the historical slurry state information. The status table may be constructed based on the historical mineralization record.

In 920, generating an auxiliary mineralization parameter in response to determining that the mineralization progress does not satisfy a preset requirement.

The preset requirement refers to a requirement set in advance for the mineralization progress. In some embodiments of the present disclosure, the preset requirement may include the mineralization progress being not less than a reference progress. In some embodiments of the present disclosure, reference progresses for different periods may be different.

In some embodiments of the present disclosure, the processor may determine, from historical mineralization records, mineralization data of mineral particles with a relatively good quality obtained from floatation, and perform statistical analysis on mineralization progresses for different periods in the mineralization data. For example, the processor determines an average mineralization progress for different periods as the reference progress. The quality of the mineral particles is determined by a technician based on prior experience.

For example, the technician obtains multiple historical mineralization records: [(X₁, Y₁), (X₁, Y₂), (X₁, Y₂)], wherein X₁ represents period 1, Y₁ represents mineralization progress 1, and Y₂ represents mineralization progress 2. If the average mineralization progress for period 1 is close to mineralization progress 2, then mineralization progress 2 is determined as the reference progress for period 1. If a current moment is within period 1 and the mineralization progress of the mineral slurry in the mineralization cylinder is at mineralization progress 1, which is below mineralization progress 2, the auxiliary mineralization parameter is generated.

The auxiliary mineralization parameter refers to a parameter used to assist mineralization and accelerate the mineralization progress. In some embodiments, the auxiliary mineralization parameter may include an auxiliary stirring parameter of an auxiliary stirring device, a heating parameter of a heating device, or the like. More about the auxiliary stirring parameter of the auxiliary stirring device and the heating parameter of the heating device may be found in the previous related description.

In some embodiments, the processor may determine the auxiliary mineralization parameter based on a difference between the mineralization progress and the reference progress. The greater the difference, the higher a rotation speed in the auxiliary stirring parameter and the higher a heating power in the heating parameter. In some embodiments, the processor may determine the mineralization progress in real time during auxiliary mineralization, and stop the auxiliary mineralization when the mineralization progress satisfy the preset requirement.

In 930, performing an auxiliary mineralization treatment based on the auxiliary mineralization parameter in response to determining that the mineralization progress satisfies the preset requirement or the mineralization is completed.

The auxiliary mineralization treatment refers to an operation used to assist in the mineralization of the mineral slurry.

The mineralization being completed refers to a condition in which the mineral particles successfully attach to bubbles and form a stable foam layer. In some embodiments, the processor stops mineralization in response to determining that mineralization is completed.

In some embodiments, the processor may determine whether mineralization is completed based on a foam characteristic through a computer vision technology. The foam characteristic may include a size, a color, a morphology, or the like, of the foam. More on the computer vision technique may be found in FIG. 8 and the related description.

In some embodiments, the processor may determine a foam stability based on slurry state information for a plurality of consecutive moments, and in response to the foam stability reaching a stability threshold, determine that mineralization is completed.

The slurry state information for a plurality of consecutive moments may be a sequence consisting of values corresponding to the slurry state information for the plurality of consecutive moments. For example, (S₁, S₂, . . . ), wherein S₁ denotes slurry state information at a first moment and S₂ denotes slurry state information at a second moment.

More descriptions on how to obtain the slurry state information may be found in FIG. 8 and the related description.

The foam stability refers to a stability level of a foam state. In some embodiments, the foam stability may include a stability in foam solidness and a stability in foam firmness.

In some embodiments, the processor may determine a difference in foam size between adjacent moments within a predetermined period, determine a maximum value and a minimum value of the difference in foam size within the predetermined period, and determine the stability in foam firmness based on a difference between the maximum value and the minimum value, thereby determining the stability of foam firmness. The smaller the difference between the maximum value and the minimum value is, the smaller a change in the foam size during the predetermined period, i.e., there is a lower likelihood of large foam bubbles breaking, thus indicating a greater stability of foam firmness.

In some embodiments, the processor may determine a maximum value and a minimum value of a foam wall thickness during the predetermined time period, and determine the stability of foam solidness based on a difference between the maximum value and the minimum value of the foam wall thickness. The smaller the difference is, the higher the stability of foam solidness is.

The foam solidness refers to a density condition of the mineral particles attached to the bubbles. In some embodiments, the greater a count of mineral particles attached to the bubbles, the higher the density of attachment, and the more solid the foam is. In some embodiments, the foam solidness may be determined by an attachment condition of the mineral particles in the slurry state information.

The foam firmness may be expressed by a numerical value, the higher the value is, the greater the foam firmness is, and the foam is less likely to break.

The predetermined period refers to a time period from a moment of starting the auxiliary mineralization treatment to a current moment.

The stability threshold refers to a threshold for determining the foam stability. For example, the stability threshold may be a difference of 3 millimeters in the foam size or a difference of 1 millimeter in the foam wall thickness during the predetermined time period. In some embodiments, the stability threshold may be obtained by the processor based on a default setting or preset by a technician based on prior experience.

In some embodiments, the stability threshold is positively correlated with a dimension of the mineralization cylinder, and negatively correlated with the second mineralization parameter and the auxiliary mineralization parameter.

The dimension of the mineralization cylinder is a diameter of a cross-section of the mineralization cylinder.

In some embodiments, the larger the dimension of the mineralization cylinder is, the more mineral slurry is contained in the mineralization cylinder, resulting in a more uneven distribution of foams in the mineralization cylinder in terms of foam solidness and foam firmness. Therefore, the stability threshold may be set higher to ensure that the overall foam stability of the slurry satisfies requirements and guarantees flotation quality.

In some embodiments, the higher the rotational speed of the stirring device and the rotational speed of the auxiliary stirring device in the second mineralization parameter and the auxiliary mineralization parameter, the slower the mineral slurry stabilizes. Thus, when assessing the foam stability, the mineral slurry may not yet be completely settled, leading to determined foam stability being lower than an actual stability. Therefore, the stability threshold may be set lower to avoid misjudgment that may lead to over-mineralization.

In some embodiments of the present disclosure, adjusting the stability threshold based on the dimension of the mineralization cylinder, the second mineralization parameter, and the auxiliary mineralization parameter is helpful to ensure that the overall foam stability of the mineral slurry meets the requirements, avoiding over-mineralization and ensuring flotation quality.

In some embodiments, in response to the foam stability reaching the stability threshold, the processor determines that the mineralization is completed and stops the mineralization.

In some embodiments of the present disclosure, the foam stability is determined based on the slurry state information for a plurality of consecutive moments, and the completion of mineralization is determined in response to the foam stability reaching the stability threshold. This is conducive to determining promptly whether mineralization is completed to stop the mineralization, thereby avoiding over-mineralization and improving mineralization efficiency.

Having thus described the basic concepts, it may be rather apparent to those skilled in the art after reading this detailed disclosure that the foregoing detailed disclosure is intended to be presented as an illustrative example and is not limiting. Various alterations, improvements, and modifications may occur and are intended for those skilled in the art, though not expressly stated herein. These alterations, improvements, and modifications are intended to be suggested by this disclosure, and are within the spirit and scope of the exemplary embodiments of the present disclosure.

Moreover, certain terminology has been configured to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be noted that in the foregoing description of embodiments of the present disclosure, various features are sometimes grouped together in a single embodiment, figure, or description thereof for the purpose of streamlining the disclosure aiding in the understanding of one or more of the various inventive embodiments. This way of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties configured to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameter set forth in the written description and attached claims are approximations that may vary depending upon the desired properties sought to be obtained by a particular embodiment. In some embodiments, the numerical parameter should be construed in light of the number of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A device for vortex flotation mineralization based on confined space, comprising a mineralizer body, wherein
an interior of the mineralizer body includes a mineralization cylinder for mineralizing minerals,
a mineral inlet is provided on a sidewall of the mineralization cylinder at a bottom of the mineralization cylinder and a mineral outlet is provided on the sidewall of the mineralization cylinder at a top of the mineralization cylinder, forming a mineralization pipeline within the mineralization cylinder that extends from the bottom to the top;
the mineral inlet includes at least two inlet pipes arranged opposite to each other such that a mineral slurry enters the mineralization cylinder in a form of a collision flow; and
the device for vortex flotation mineralization further comprises an air pipeline and a stirring device, wherein the air pipeline is connected to the mineral inlet and configured to inject air into the mineral slurry, and the stirring device is provided with a mineralization impeller for stirring, the mineralization impeller being positioned above a collision flow path between the at least two inlet pipes.

2. The device of claim 1, wherein a mineral entry end of the mineral inlet is arranged on a slurry distribution trough, which is a sealed conduit surrounding an outer sidewall at the top of the mineralization cylinder,
the slurry distribution trough is connected to vertically arranged slurry distribution pipes, a count of the slurry distribution pipes matching a count of the at least two inlet pipes, and
the mineral slurry enters the slurry distribution trough and flows through the slurry distribution pipes into the inlet pipes to intensify collision.

3. The device of claim 1, wherein a lined jet pipe is provided at a connection between each of the at least two inlet pipes and the mineralization cylinder, and the lined jet pipe penetrates the sidewall of the mineralization cylinder and extends a set distance into an interior of the mineralization cylinder.

4. The device of claim 3, wherein an automatic valve is provided inside the lined jet pipe, the automatic valve is configured to regulate an impact force of the mineral slurry entering the mineralization cylinder to adjust an intensity of the collision flow.

5. The device of claim 2, wherein a lined jet pipe is provided at a connection end of each of the slurry distribution pipes connected to the slurry distribution trough, and the slurry distribution trough delivers the mineral slurry into the slurry distribution pipes through the lined jet pipe.

6. The device of claim 5, wherein the air pipeline is positioned on a side of each of the slurry distribution pipes near the corresponding lined jet pipe, and the air injected from the air pipeline is dispersed into fine bubbles by the lined jet pipe and mixed with the mineral slurry.

7. The device of claim 1, wherein the interior of the mineralization cylinder includes a plurality of horizontally arranged annular plates, edges of the plurality of annular plates are tightly connected to an inner wall of the mineralization cylinder, each of the annular plates has a central hole through which the mineral slurry flows; and
the plurality of annular plates divide the mineralization cylinder into interconnected chambers to enhance different stages of a mineralization process within the mineralization cylinder.

8. The device of claim 7, wherein a first annular plate is arranged between the mineral inlet and the mineralization impeller, the first annular plate and the bottom of the mineralization cylinder form a collision flow mineralization chamber; and
a second circular plate is arranged below the mineral outlet, the second annular plate and the top of the mineralization cylinder forms a slurry discharge chamber.

9. The device of claim 8, wherein a central annular plate is arranged between the second annular plate and the first annular plate, a dispersion circulation mineralization chamber is formed between the central annular plate and the second annular plate, and a vortex-forced mineralization chamber is formed between the central annular plate and the first annular plate.

10. The device of claim 9, wherein each of an upper surface and a lower surface of the central annular plate is provided with liners arranged radially around a periphery of the central hole of the central annular plate, a long side of each of the liners fits against the inner wall of the mineralization cylinder, and a width of each of the liners is shorter than an annular width of the central annular plate.

11. The device of claim 1, wherein a top end of the mineralization cylinder is sealed by a sealing cover plate, and the bottom of the mineralization cylinder is provided with a discharge pipe for discharging a residual slurry.

12. The device of claim 1, wherein the mineralizer body is further connected to a power device, the power device being electrically connected to the stirring device in the mineralizer body.

13. The device of claim 1, wherein the stirring device is provided with a mixing and aeration unit, the mixing and aeration unit includes an air inlet, an aeration pipe, and an aeration outlet, and the mixing and aeration unit is configured to introduce air to a stirring center of the stirring device during stirring.

14. The device of claim 1, wherein an auxiliary stirring device is provided at the bottom of the mineralization cylinder, the auxiliary stirring device is configured to stir the mineral slurry at the bottom of the mineralization cylinder to achieve thorough mineralization of the mineral slurry.

15. A method for mineralization using the device for vortex flotation mineralization based on confined space of claim 1, the method comprising:
closing a discharge pipe and feeding minerals, opening the air pipeline to introduce air into slurry distribution pipes; allowing the mineral slurry to mix with the air for mineralization within the slurry distribution pipes; feeding the mineralized mineral slurry, through the mineral inlet, into an interior of the mineralization cylinder via the inlet pipes in the form of the collision flow;
after the mineral slurry inside the mineralization cylinder reaches a set liquid level, activating the stirring device to disperse the air in the mineral slurry into fine bubbles to enhance the mineralization between the air and mineral particles in the mineral slurry;
allowing the mineral particles to collide with the bubbles for mineralization within the mineralization cylinder, discharging the mineral slurry through the mineral outlet, and collecting the discharged slurry for subsequent processing; and
after the mineralization is completed, sequentially closing the air pipeline and the stirring device, stopping the feeding of the minerals, opening the discharge pipe, and emptying a residual slurry from the mineralization cylinder.

16. The method of claim 15, further comprising:
determining a first mineralization parameter based on an initial slurry characteristic;
performing, based on the first mineralization parameter, a first mineralization treatment on a raw slurry within a first slurry distribution pipe to obtain a first slurry;
determining a second mineralization parameter based on slurry state information of the first slurry and the initial slurry characteristic; and
performing, based on the second mineralization parameter, a second mineralization treatment on the first slurry to obtain a second slurry.

17. The method of claim 16, wherein the second mineralization parameter includes a valve level of an automatic valve, and the determining a second mineralization parameter based on slurry state information of the first slurry and the initial slurry characteristic includes:
evaluating collision efficiency based on slurry collision information;
adjusting the valve level based on the collision efficiency; and
determining a stirring parameter of the stirring device based on the slurry state information and the initial slurry characteristic.

18. The method of claim 15, further comprising:
determining a mineralization progress based on the slurry state information during a stirring process;
generating an auxiliary mineralization parameter in response to determining that the mineralization progress does not satisfy a preset requirement; and
performing an auxiliary mineralization treatment based on the auxiliary mineralization parameter in response to determining that the mineralization progress satisfies the preset requirement or the mineralization is completed.

19. The method of claim 18, wherein determining whether the mineralization is completed includes:
determining a foam stability based on the slurry state information for a plurality of consecutive moments; and
determining that the mineralization is completed in response to determining that the foam stability reaches a stability threshold.

20. The method of claim 19, wherein the stability threshold is positively correlated with a dimension of the mineralization cylinder and negatively correlated with the second mineralization parameter and the auxiliary mineralization parameter.
